(19) United States
(12) Patent Application Publication
(10) Pub. No.: US 2015/0217985 A1
(43) Pub. Date: Aug. 6, 2015

(54) REGULATED DRINK DISPENSING SYSTEM

(71) Applicant: William Thomas Raley, Houston, TX (US)

(72) Inventor: William Thomas Raley, Houston, TX (US)

(21) Appl. No.: 14/561,964

(22) Filed: Dec. 5, 2014

Related U.S. Application Data
(60) Provisional application No. 61/935,067, filed on Feb. 3, 2014.

(51) Int. Cl. B67D 1/08

(52) U.S. Cl. CPC B67D 1/0888

(57) ABSTRACT

A regulated drink dispensing system includes a first RFID read/write device, a drink container that includes a RFID readable/writeable tag, and a second RFID read/write device operably connected to a drink dispenser. The first RFID read/write device is configured to write one or more drink dispensing restrictions to the RFID readable/writeable tag. The second RFID read/write device is configured to read the one or more drink dispensing restrictions from the RFID readable/writeable tag. The drink dispenser regulates dispensing according to the one or more drink dispensing restrictions.

### CROSS-REFERENCE TO RELATED APPLICATIONS

This application claims the benefit of, or priority to, U.S. Provisional Patent Application Ser. No. 61/935,067, filed on Feb. 3, 2014, which is hereby incorporated by reference in its entirety.

### BACKGROUND OF THE INVENTION

Conventional drink dispensers are commonly used to dispense beverages including carbonated soft drinks. Carbonated soft drink dispensers typically include a carbonated water source, one or more flavored syrup sources, and one or more dispensing nozzles. At or near the time of dispensing, carbonated water is mixed with flavored syrup to provide a selected soft drink through a dispensing nozzle.

In conventional carbonated soft drink dispensers, there is a dedicated dispensing nozzle for each type of soft drink offered. Because each type of soft drink requires a dedicated nozzle, the types of soft drinks offered are typically limited to a small number. In operation, the user places a drink container under a nozzle of a selected soft drink and depresses a lever or pushes a button to dispense the beverage. Alternatively, there may be a single dispensing nozzle that is shared among the various types of soft drinks offered. For example, the Coca-Cola® Freestyle is a touchscreen driven self-serve carbonated soft drink dispenser that uses a single dispensing nozzle to dispense more than one hundred different types of soft drinks In operation, the user selects a type of soft drink, places a drink container under the nozzle, and depresses a lever or presses a button to dispense the beverage.

Drink dispensers may also be used to dispense coffee, beer, wine, liquor, and other types of beverages that do not necessarily require mixture.

### BRIEF SUMMARY OF THE INVENTION

According to one aspect of one or more embodiments of the present invention, a regulated drink dispensing system includes a first radio frequency identification (“RFID”) read/write device, a drink container that includes a RFID readable/writeable tag, and a second RFID read/write device operably connected to a drink dispenser. The first RFID read/write device is configured to write one or more drink dispensing restrictions to the RFID readable/writeable tag. The second RFID read/write device is configured to read the one or more drink dispensing restrictions from the RFID readable/writeable tag. The drink dispenser regulates dispensing according to the one or more drink dispensing restrictions.

According to one aspect of one or more embodiments of the present invention, a method of regulating drink dispensing includes identifying a drink container that includes a RFID readable/writeable tag in proximity to a first RFID read/write device, writing one or more drink dispensing restrictions to the RFID readable/writeable tag with the first RFID read/write device, identifying the drink container in proximity to a second RFID read/write device, reading the one or more drink dispensing restrictions from the RFID readable/writeable tag with a second RFID read/write device, and regulating dispensing by a drink dispenser according to the one or more drink dispensing restrictions.

Other aspects of the present invention will be apparent from the following description and claims.

### BRIEF DESCRIPTION OF THE DRAWINGS

FIG. 1 shows a block diagram of a regulated drink dispensing system in accordance with one or more embodiments of the present invention.

FIG. 2 shows a drink container with a RFID readable/writeable tag in accordance with one or more embodiments of the present invention.

FIG. 3 shows a point-of-sale system with a first RFID read/write device configured to write one or more drink dispensing restrictions to a RFID readable/writeable tag in accordance with one or more embodiments of the present invention.

FIG. 4 shows a stand-alone system with a first RFID read/write device configured to write one or more drink dispensing restrictions to a RFID readable/writeable tag in accordance with one or more embodiments of the present invention.

FIG. 5 shows a drink dispenser with a second RFID read/write device configured to read one or more drink dispensing restrictions from a RFID readable/writeable tag in accordance with one or more embodiments of the present invention.

### DETAILED DESCRIPTION OF THE INVENTION

One or more embodiments of the present invention are described in detail with reference to the accompanying figures. For consistency, like elements in the various figures are denoted by like reference numerals. In the following detailed description of the present invention, specific details are set forth in order to provide a thorough understanding of the present invention. In other instances, well-known features to one of ordinary skill in the art are not described to avoid obscuring the description of the present invention.

Conventional RFID technology uses electromagnetic signals in the radio frequency (“RF”) spectrum to wirelessly read and/or write data to one or more commercially available transponders, also referred to as tags. Tags may be passively powered, semi-active powered, or active powered. Passively powered tags do not include an internal power source and are powered by incident RF energy when in proximity to a RFID read/write device. Because no internal power source is required, passively powered tags typically have a limited range, are comparatively inexpensive, and have a small footprint. Semi-active powered tags include an internal power source and are powered by the internal power source and incident RF energy. Semi-active powered tags typically have a larger range, are more expensive, and have a larger footprint than passively powered tags. Powered tags include an internal power source and are not powered by the incident RF energy. Powered tags typically have the largest range, are more expensive, and have a larger footprint than semi-active powered tags.

The RF used to wirelessly communicate with the tags may vary based on an application or design. Commercially available RFID read/write devices and tags are typically offered for use in low frequency, high frequency, ultra-high frequency, and/or super-high frequency application or designs. In certain embodiments, low frequency RFID radio signals with a frequency in a range between 125 kHz and 134.2 kHz may be used. In other embodiments, high frequency RFID radio signals with a frequency of 13.56 MHz may be used. In still other embodiments, ultra-high frequency RFID radio signals with a frequency in a range between 860 MHz and 960 MHz may be used. In still other embodiments, super-high frequency RFID radio signals with a frequency of 2.45 GHz may be used. One of ordinary skill in the art will recognize that other radio frequencies may be used in accordance with one or more embodiments of the present invention.

Each tag has memory that typically includes fixed data area and a programmable data area. The fixed data area typically includes a number of bits or bytes that are static, non-volatile, and cannot be modified and a number of bits or bytes that are programmable and may be used to store user-defined information. For example, the tag may include a fixed unique identification data area that stores a unique identifier of the tag, a programmable password data area that stores a password used to secure reads and/or writes to the tag, and a programmable user data area where user-defined data may be written to, or read from, the tag.

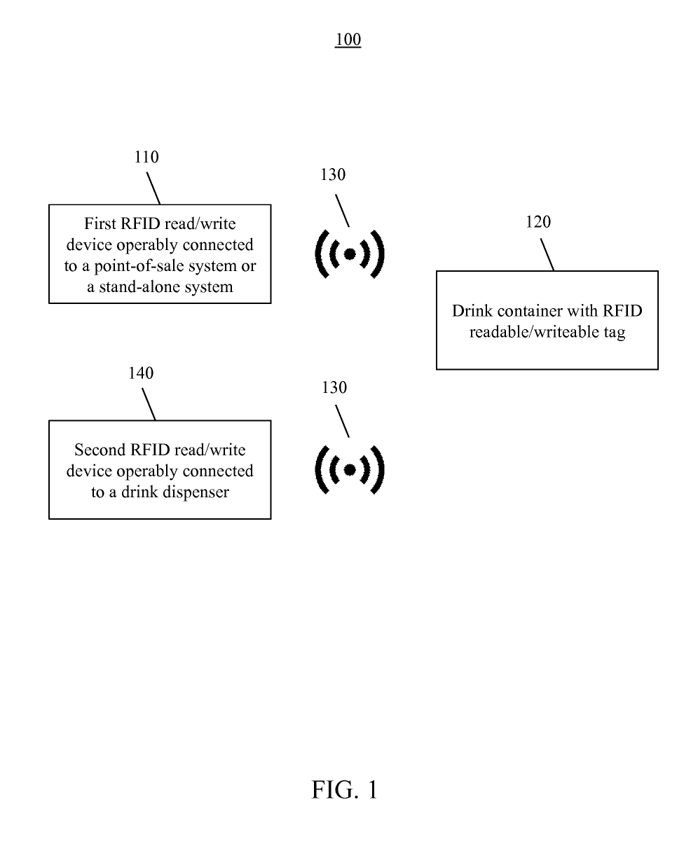

FIG. 1 shows a block diagram of a regulated drink dispensing system 100 in accordance with one or more embodiments of the present invention. Regulated drink dispensing system 100 may include a first RFID read/write device 110 that may be operably connected to a point-of-sale system (not independently illustrated) or a stand-alone system (not independent illustrated). The first RFID read/write device 110 may be a commercially available RFID read/write device. The connection between the first RFID read/write device 110 and the point-of-sale system or the stand-alone system may vary based on an application or design and a type of RFID read/write device 110 selected for use. Commercially available RFID read/write devices 110 are available using Universal Serial Bus (“USB”), serial, parallel, or proprietary bus connections. One of ordinary skill in the art will recognize that other connections may be used in accordance with one or more embodiments of the present invention. The point-of-sale system or the stand-alone system may be used to input one or more drink dispensing restrictions corresponding to a customer's selection. An operator may input the one or more drink dispensing restrictions using a human-computer interface of the point-of-sale system or the stand-alone system such as a keyboard, a mouse, or a touchscreen. The one or more drink dispensing restrictions may include one or more of a date of purchase, an expiration date, a type of drink to dispense, a volume of drink to dispense, a number of refills permitted, an indication of whether alcoholic beverages are permitted, a number of alcoholic beverages permitted, a number of alcoholic beverages dispensed, one or more customer preferences, and/or other customer information including payment or running tab information. One of ordinary skill in the art will recognize that the one or more drink dispensing restrictions may include other information in accordance with one or more embodiments of the present invention.

The point-of-sale system or the stand-alone system may include a microcontroller (not independently illustrated) configured to cause the first RFID read/write device 110 to wirelessly 130 write the one or more drink dispensing restrictions to a RFID readable/writeable tag (not independently illustrated) of a drink container 120 in proximity to the first RFID read/write device 110. The microcontroller may provide a sequence of instructions to the first RFID read/write device 110 that may be proprietary to the type of first RFID read/write device 110 used. The instruction sequence may include, for example, the provision of credentials, addressing information, and data. The one or more drink dispensing restrictions may be encoded and stored in the tag in a format suitable for a given RFID readable/writeable tag including, for example, hexadecimal representation. The first RFID read/write device 110 may be a commercially available RFID read/write device. The proximity required for proper operation may vary based on an application or design including the type of first RFID read/write device 110 used and the type of RFID readable/writeable tag used. In certain embodiments, the RFID readable/writable tag may be coupled to the drink container 120. For example, the RFID readable/writeable tag may include an adhesive surface that is used to couple the tag to a surface of the drink container 120. In other embodiments, the RFID readable/writeable tag may be integrated into the drink container 120. For example, the RFID readable/writeable tag may be integrated into, for example, an injection molded, thermoformed, or thermoset drink container 120 at the time of fabrication.

A second RFID read/write device 140 may be operably connected to a drink dispenser. The second RFID read/write device 140 may be a commercially available RFID read/write device. The connection between the second RFID read/write device 140 and the point-of-sale system or the stand-alone system may vary based on an application or design and a type of RFID read/write device 140 selected for use. Commercially available RFID read/write devices 140 are available using USB, serial, parallel, or proprietary bus connections. The drink dispenser may include a microcontroller (not independently illustrated) configured to regulate dispensing in accordance with the one or more drink dispensing restrictions. When the customer places the drink container 120 in proximity to the second RFID read/write device 140, the second RFID read/write device 140 may be configured to wirelessly 130 read the one or more drink dispensing restrictions from the RFID readable/writeable tag. The drink dispenser may dispense a drink into the drink container 140 in accordance with the one or more drink dispensing restrictions.

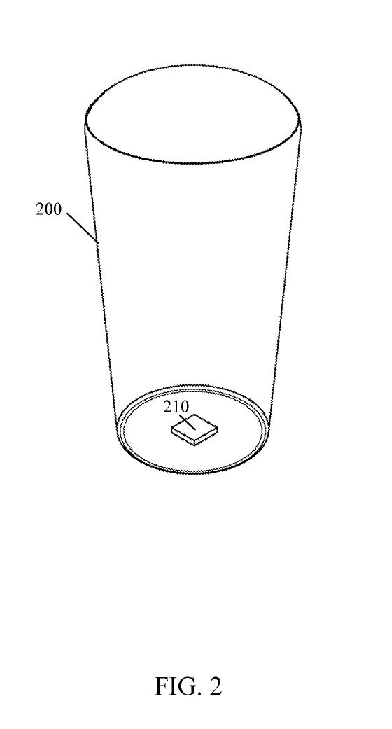

FIG. 2 shows a drink container 200 with a RFID readable/writeable tag 210 in accordance with one or more embodiments of the present invention. Drink container 200 may be a conventional container capable of holding a beverage. Drink container 200 may be composed of, for example, paper, plastic, polymer, metal, ceramic, glass, or composites thereof. One of ordinary skill in the art will recognize that drink container 200 may have a size and a shape that may vary based on an application or design in accordance with one or more embodiments of the present invention. One of ordinary skill in the art will also recognize that a type of drink container 200 used may vary based on an application or design in accordance with one or more embodiments of the present invention.

In certain embodiments, RFID readable/writeable tag 210 may be coupled to drink container 200. In other embodiments, RFID readable/writeable tag 210 may be integrated into drink container 200 (not shown). In certain embodiments, RFID readable/writeable tag 210 may be passively powered. In other embodiments, RFID readable/writeable tag 210 may be semi-active powered. In still other embodiments, RFID readable/writeable tag 210 may be active powered. One of ordinary skill in the art will recognize that a type of tag 210 used may vary based on an application or design in accordance with one or more embodiments of the present invention. The RFID readable/writeable tag 210 may be placed anywhere on, in, or about drink container 200 suitable for reading and writing the tag 210. However, in applications using passively powered tags 210 with limited range, the bottom of the drink container 200 may be preferable to ensure consistent reading and writing of the tag 210. In certain embodiments, it may be preferable to place the RFID readable/writeable tag 210 in a location that is substantially parallel to a RFID read/write device (not shown).

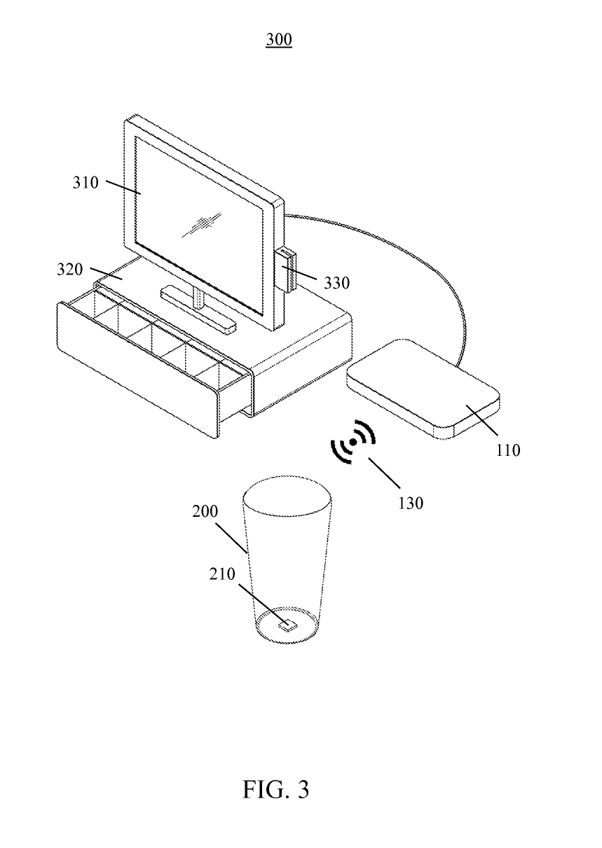

FIG. 3 shows a point-of-sale system 300 with a first RFID read/write device 110 configured to write one or more drink dispensing restrictions to a RFID readable/writeable tag 210 in accordance with one or more embodiments of the present invention. A point-of-sale system 300 may be used at a point of purchase to facilitate customer sales including drink sales. The point-of-sale system 300 may include a computer (not independently illustrated), a human-computer interface (not independently illustrated), a display device 310, a cash drawer 320, a credit card reader 330, a microcontroller (not independently illustrated), and a first RFID read/write device 110. In certain embodiments, the display device 310 may be a touch screen configured to serve as the human-computer interface by sensing touch or gestures on the display 310. In other embodiments, a keyboard, a mouse, or other device (not shown) may serve as the human-computer interface. One of ordinary skill in the art will recognize that the human-computer interface may vary based on an application or design in accordance with one or more embodiments of the present invention.

At the point of purchase, an operator of the point-of-sale system 300 may input one or more drink dispensing restrictions corresponding to a customer's selection via the human-computer interface. When a drink container 200 is in proximity to the first RFID read/write device 110, the system 300 may be configured to cause the first RFID read/write device 110 to wirelessly 130 write the one or more drink dispensing restrictions to the RFID readable/writeable tag 210 of the drink container 200. For example, the first RFID read/write device 110 may have a USB, serial, parallel, or proprietary data interface for inputting instructions and/or data that may be provided by the point-of-sale system 300. The instructions may include instructions to wirelessly 130 place the RFID readable/writeable tag 210 in a writeable mode by, for example, providing a password and writing data including the one or more drink dispensing restrictions to the RFID readable/writeable tag 210. One of ordinary skill in the art will recognize that the data interface for inputting instructions and/or data to the first RFID read/write device 110 may vary based on an application or design. One of ordinary skill in the art will also recognize that the programming interface for the first RFID read/write device 110 may vary based on an application or design.

The proximity required for proper operation may depend on the type of RFID readable/writeable tag 210 used, the nominal distance between the RFID readable/writeable tag 210 and an antenna (not independently illustrated) of the RFID read/write device 110, and the signaling environment. In certain embodiments, the proximity required for proper operation may be in a range between approximately 1 inch and approximately 3 inches. In other embodiments, the proximity required for proper operation may be in range between approximately 3 inches and approximately 6 inches. In still other embodiments, the proximity required for proper operation may be greater than approximately 6 inches. One of ordinary skill in the art will recognize that the proximity required for proper operation may vary based on an application or design in accordance with one or more embodiments of the present invention.

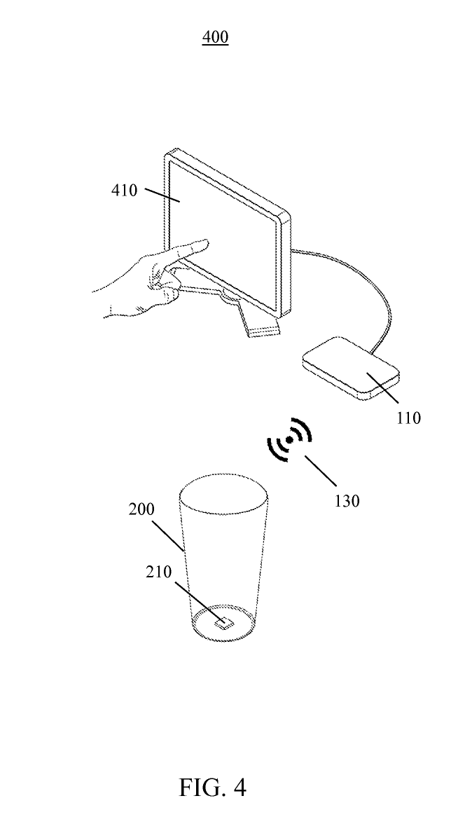

FIG. 4 shows a stand-alone system 400 with a first RFID read/write device 110 configured to write one or more drink dispensing restrictions to a RFID readable/writeable tag 210 in accordance with one or more embodiments of the present invention. A stand-alone system 400 may be used at a point of purchase or other location to facilitate the programming of the RFID readable/writeable tag 210 of a drink container 200. The stand-alone system 400 may be dedicated to the programming of the RFID readable/writeable tag 210. The stand-alone system 400 may include a computer (not independently illustrated), a human-computer interface (not independently illustrated), a display device 410, a microcontroller (not independently illustrated), and a first RFID read/write device 110. In certain embodiments, the display device 410 may be a touch screen configured to serve as the human-computer interface by sensing touch or gestures on the display 410. In other embodiments, a keyboard, a mouse, or other device (not shown) may serve as the human-computer interface. One of ordinary skill in the art will recognize that the human-computer interface may vary based on an application or design in accordance with one or more embodiments of the present invention.

At the point of purchase, an operator of the stand-alone system 400 may input one or more drink dispensing restrictions corresponding to a customer's selection via the human-computer interface. When a drink container 200 is in proximity to the first RFID read/write device 110, the system 400 may be configured to cause the first RFID read/write device 110 to wirelessly 130 write the one or more drink dispensing restrictions to the RFID readable/writeable tag 210 of the drink container 200. For example, the first RFID read/write device 110 may have a USB, serial, parallel, or proprietary data interface for inputting instructions and/or data for the first RFID read/write device 110 to operate on that may be provided by the stand-alone system 400. The instructions may include instructions to wirelessly 130 place the RFID readable/writeable tag 210 in a writeable mode by, for example, providing a password, and write data including the one or more drink dispensing restrictions to the RFID readable/writeable tag 210. One of ordinary skill in the art will recognize that the data interface for inputting instructions and/or data to the first RFID read/write device 110 may vary based on an application or design. One of ordinary skill in the art will also recognize that the programming interface for the first RFID read/write device 110 may vary based on an application or design.

The proximity required for proper operation may depend on the type of RFID readable/writeable tag 210 used, the nominal distance between the RFID readable/writeable tag 210 and an antenna (not independently illustrated) of the first RFID read/write device 110, and the signaling environment. In certain embodiments, the proximity required for proper operation may be in a range between approximately 1 inch and approximately 3 inches. In other embodiments, the proximity required for proper operation may be in range between approximately 3 inches and approximately 6 inches. In still other embodiments, the proximity required for proper operation may be greater than approximately 6 inches. One of ordinary skill in the art will recognize that the proximity required for proper operation may vary based on an application or design in accordance with one or more embodiments of the present invention.

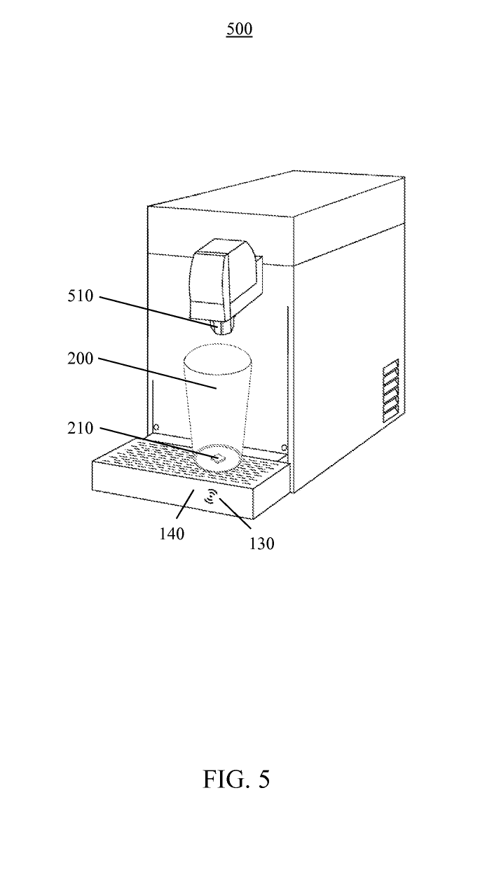

FIG. 5 shows a drink dispenser 500 with a second RFID read/write device 140 configured to read one or more drink dispensing restrictions from a RFID readable/writeable tag 210 in accordance with one or more embodiments of the present invention. The drink dispenser 500 regulates dispensing in accordance with the one or more drink dispensing restrictions. In certain embodiments where drink dispenser 500 is a carbonated soft drink dispenser, drink dispenser 500 may include a carbonated water source (not shown), one or more flavored syrup sources (not shown), and a dispensing nozzle 510. The drink dispenser 500 may also include a microcontroller (not shown), a second RFID read/write device 140, and an optional display or touch screen (not shown).

The second RFID read/write device 140 may be disposed under the nozzle 510 of the drink dispenser 500 to facilitate communication with RFID readable/writeable tag 210 on the bottom of drink container 200 when it is in a dispensing location. When a drink container 200 is in proximity to the second RFID read/write device 140, the drink dispenser 500 may be configured to cause the second RFID read/write device 140 to wirelessly 130 read the one or more drink dispensing restrictions from the RFID readable/writeable tag 210 of the drink container 200 and automatically dispense a drink into the drink container 200 in accordance with the one or more drink dispensing restrictions. For example, the second RFID read/write device 140 may have a USB, serial, parallel, or proprietary data interface for inputting instructions and/or data for the second RFID read/write device 140 to operate on. The instructions may include instructions to wirelessly 130 read the one or more drink dispensing restrictions from the RFID readable/writeable tag 210, place the RFID readable/writeable tag 210 in a writeable mode by, for example, providing a password, and updating the one or more drink dispensing restrictions. One of ordinary skill in the art will recognize that the data interface for inputting instructions and/or data to the second RFID read/write device 140 may vary based on an application or design. One of ordinary skill in the art will also recognize that the programming interface for the second RFID read/write device 140 may vary based on an application or design.

When the drink container 200 is in proximity to the second RFID read/write device 140, the drink dispenser 500 may dispense a drink (not shown) into the drink container 200. In certain embodiments, the drink may be dispensed without any further action required by the customer in a hands-free manner with respect to the drink dispenser 500. For example, the customer may place the drink container 200 under the nozzle 510, the drink dispenser 500 may read the one or more drink dispensing restrictions that may include a type of drink to dispense, and the drink dispenser 500 may dispense the drink in accordance with the one or more drink restrictions. In other embodiments, drink dispenser 500 may read the one or more drink dispensing restrictions and present the customer with one or more options on an optional display or touch screen (not shown). For example, the customer may place the drink container 200 under the nozzle 510, the drink dispenser 500 may read the one or more drink dispensing restrictions, and the drink dispenser 500 may present the customer with one or more options on the optional display or touch screen that requires further input from the customer prior to dispensing the drink.

The proximity required for proper operation may depend on the type of RFID readable/writeable tag 210 used, the nominal distance between the RFID readable/writeable tag 210 and the antenna (not independently illustrated) of the second RFID read/write device 140, and the signaling environment. In certain embodiments, the proximity required for proper operation may be in a range between approximately 1 inch and approximately 3 inches. In other embodiments, the proximity required for proper operation may be in range between approximately 3 inches and approximately 6 inches. In still other embodiments, the proximity required for proper operation may be greater than approximately 6 inches. One of ordinary skill in the art will recognize that the proximity required for proper operation may vary based on an application or design in accordance with one or more embodiments of the present invention.

A method of regulating drink dispensing may include identifying a drink container that includes a RFID readable/writeable tag in proximity to a first RFID read/write device. The first RFID read/write device may be configured to loop in a discovery mode where the first RFID read/write device broadcasts a request for a RFID readable/writeable tag to identify itself. Once identified, the first RFID read/write device may write one or more drink dispensing restrictions to the RFID readable/writeable tag. The write operation may require the provision of credentials, such as a password, before certain data areas of the RFID readable/writeable tag are readable and/or writeable. The one or more drink dispensing restrictions may be written to multiple locations to provide redundancy and improve reliability. In addition, the first RFID read/write device may read back the one or more drink dispensing restrictions to ensure the data was accurately written. The one or more drink dispensing restrictions and other data on the RFID readable/writeable tag may be password protected, encrypted, or otherwise protected from tampering. The second RFID read/write device of the drink dispenser may be configured to loop in a discovery mode where the second RFID read/write device broadcasts a request for a RFID readable/writeable tag to identify itself. When the customer wishes to dispense a drink, the customer places the drink container under the nozzle of the drink dispenser. The second RFID read/write device may identify the drink container in proximity to the second RFID read/write device. Once identified, the second RFID read/write device may read the one or more drink dispensing restrictions from the RFID readable/writeable tag. The drink dispenser may regulate dispensing according the one or more drink dispensing restrictions. The second RFID read/write device may update the one or more drink dispensing restrictions to the RFID readable/writeable tag. The update may occur after identification and before or after the dispensing of the drink.

The one or more drink dispensing restrictions may include one or more of a date of purchase, an expiration date, a type of drink to dispense, a volume of drink to dispense, a number of refills permitted, an indication of whether alcoholic beverages are permitted, a number of alcoholic beverages dispensed, one or more customer preferences, and/or other customer information including payment or running tab information. The one or more drink dispensing restrictions may be encoded and stored in the tag in a format suitable for a given RFID readable/writeable tag including, for example, hexadecimal representation. One of ordinary skill in the art will recognize that the one or more drink dispensing restrictions may include other information in accordance with one or more embodiments of the present invention.

In a first usage example, a regulated drink dispenser may regulate the dispensing of drinks. At a point of purchase, a customer selects, for example, a type of drink, a volume or size of drink, and/or a number of refills that he or she wishes to purchase. The first RFID read/write device writes the one or more drink dispensing restrictions to a RFID readable/writeable tag of a drink container. The customer then takes the drink container to the drink dispenser. A second RFID read/write device reads the one or more drink dispensing restrictions from the RFID readable/writeable tag of the drink container and the drink dispenser automatically dispenses the selected drink in accordance with the one or more drink dispensing restrictions. The drink dispenser dispenses the drink with minimal customer interaction with the drink dispenser. The second RFID read/write device may update the one or more drink dispensing restrictions including, for example, decrementing the number of refills permitted.

In a second usage example, a regulated drink dispenser may regulate the dispensing of alcoholic beverages. At a point of purchase, a customer selects, for example, a type of alcoholic beverage, a volume or size of drink, and/or a number of refills that he or she wishes to purchase. The first RFID read/write device writes the one or more drink dispensing restrictions to a RFID readable/writeable tag of a drink container. The one or more drink dispensing restrictions may include an indication of whether alcoholic beverages are permitted, a number of alcoholic beverages permitted, a number of alcoholic beverages dispensed, and/or a number of alcoholic beverages dispensed in a given period of time. The customer then takes the drink container to the drink dispenser. A second RFID read/write device reads the one or more drink dispensing restrictions from the RFID readable/writeable tag of the drink container and the drink dispenser automatically dispenses the selected drink in accordance with one or more drink dispensing restrictions. The drink dispenser dispenses the drink with minimal customer interaction. The second RFID read/write device may update the one or more drink dispensing restrictions including, for example, decrementing the number of refills permitted.

In a third usage example, a regulated drink dispenser may regulate the dispensing of drinks of different value. For example, water or other low value drinks may be offered at little or no charge. However, there is no regulation of conventional self-serve drink dispensers. At a point of purchase, a customer selects a type of beverage such as, for example, water or other low value drink or a soft drink. The first RFID read/write device writes the one or more drink dispensing restrictions to a RFID readable/writeable tag of a drink container. The customer then takes the drink container to the drink dispenser. A second RFID read/write device reads the one or more drink dispensing restrictions from the RFID readable/writeable tag of the drink container and the drink dispenser automatically dispenses the correct drink in accordance with one or more drink dispensing restrictions. The drink dispenser dispenses the drink with minimal customer interaction. The second RFID read/write device may update the one or more drink dispensing restrictions including, for example, decrementing the number of refills permitted.

In a fourth usage example, a regulated drink dispenser may regulate the dispensing of drinks according to a customer visit. For example, a customer that visits an establishment on a certain day and purchases a drink with one or more refills may be restricted to using the drink container on the day of purchase only. The first RFID read/write device writes the one or more drink dispensing restrictions to a RFID readable/writeable tag of a drink container. The customer then takes the drink container to the drink dispenser. A second RFID read/write device reads the one or more drink dispensing restrictions from the RFID readable/writeable tag of the drink container and the drink dispenser automatically dispenses the correct drink in accordance with one or more drink dispensing restrictions. If the customer attempts to use the drink container on a different day, the drink dispenser would not dispense the drink. The drink dispenser dispenses the drink with minimal customer interaction. The second RFID read/write device may update the one or more drink dispensing restrictions including, for example, decrementing the number of refills permitted.

In a fifth usage example, a regulated drink dispenser may use pre-programmed drink containers that include one or more drink dispensing restrictions. For example, drink containers may be pre-programmed with a type of drink to dispense. A customer that wishes to dispense a certain type of drink simply selects the pre-programmed cup that reflects his or her dispensing choice and takes the drink container to the drink dispenser. A second RFID read/write device reads the one or more drink dispensing restrictions from a RFID readable/writeable tag of the drink container and the drink dispenser automatically dispenses the selected drink in accordance with the one or more drink dispensing restrictions. The drink dispenser dispenses the drink with minimal interaction. The second RFID read/write device may update the one or more drink dispensing restrictions.

In a sixth usage example, a regulated drink dispensing system may be used to track customer account information or a running tab. A portion of the programmable user-defined data area of the RFID readable/writeable tag may be used to store purchase information and payment information providing a virtual wallet for the customer's drink purchases.

In a seventh usage example, a regulated drink dispensing system may be used to track customer usage metrics, customer loyalty program information, or any other customer information.

Advantages of one or more embodiments of the present invention may include one or more of the following:

In one or more embodiments of the present invention, a regulated drink dispensing system may efficiently and economically regulate the dispensing of drinks The regulated drink dispensing system may use conventional commercially available RFID read/write devices and RFID readable/writeable tags. Passive RFID readable/writeable tags are small and inexpensive.

In one or more embodiments of the present invention, a regulated drink dispensing system may reduce or eliminate customer interaction with the drink dispenser allowing for hands-free operation with respect to the drink dispenser.

In one or more embodiments of the present invention, a regulated drink dispensing system may be used to regulate, for example, one or more of a type of drink to dispense, a volume of drink to dispense, and/or a number of drink refills permitted.

In one or more embodiments of the present invention, a regulated drink dispensing system may be used to regulate the dispensing of alcoholic beverages. The drink dispenser may regulate, for example, whether the dispensing of alcoholic beverages is permitted, limit a number of alcoholic beverages dispensed, and/or limit a number of alcoholic beverages dispensed in a certain amount of time.

In one or more embodiments of the present invention, a regulated drink dispensing system may be used to dispense drinks according to one or more pre-programmed drink containers. A customer may select a pre-programmed drink container that corresponds to the type of drink they wish to dispense.

In one or more embodiments of the present invention, a regulated drink dispensing system may be used to dispense drinks according to one or more customer preferences.

In one or more embodiments of the present invention, a regulated drink dispensing system may be used to track one or more customer metrics.

In one or more embodiments of the present invention, a regulated drink dispensing system may be used to maintain a customer's account or running tab of customer charges for drinks purchased. For example, when a drink is dispensed a purchase price may be charged to a customer's account or running tab. As a consequence, a customer's account or running tab may be handled more easily and efficiently.

In one or more embodiments of the present invention, a regulated drink dispensing system may allow for the design of drink dispensers in new form factors with components that may or may not be co-located with the drink dispenser.

In one or more embodiments of the present invention, a regulated drink dispensing system may simplify the design of a drink dispenser.

In one or more embodiments of the present invention, a regulated drink dispensing system may simplify the operation of a drink dispenser.

In one or more embodiments of the present invention, a regulated drink dispensing system may improve the efficiency of a drink dispenser and drink dispensing operations.

In one or more embodiments of the present invention, a regulated drink dispensing system may improve the profitability of a drink dispenser. Drink dispensers are commonly used because they offer a lower cost alternative to the provision of beverages. However, because conventional drink dispensers are typically self-serve, customers may dispense more beverages than they would if served by a server. As a consequence, self-serve customers may consume more beverages than they normally would if served reducing the profitability of the drinks The regulated drink dispensing system may be used to require a customer to pay for a beverage and one or more refills at the time of purchase and regulate the dispensing of drinks according to what they paid for.

In one or more embodiments of the present invention, a regulated drink dispensing system may prevent a customer from ordering a low cost or free drink, such as, for example, water and dispense a higher cost drink such as, for example, a soft drink.

While the present invention has been described with respect to the above-noted embodiments, those skilled in the art, having the benefit of this disclosure, will recognize that other embodiments may be devised that are within the scope of the invention as disclosed herein. Accordingly, the scope of the invention should be limited only by the appended claims.

What is claimed is:

1. A regulated drink dispensing system comprising:
a first RFID read/write device;
a drink container comprising a RFID readable/writeable tag; and
a second RFID read/write device operably connected to a drink dispenser,
wherein the first RFID read/write device is configured to write one or more drink dispensing restrictions to the RFID readable/writeable tag,
wherein the second RFID read/write device is configured to read the one or more drink dispensing restrictions from the RFID readable/writeable tag, and
wherein the drink dispenser regulates dispensing according to the one or more drink dispensing restrictions.

2. The regulated drink dispensing system of claim 1, wherein the first RFID read/write device is operably connected to a point-of-sale system.

3. The regulated drink dispensing system of claim 1, wherein the first RFID read/write device is operably connected to a stand-alone system.

4. The regulated drink dispensing system of claim 1, wherein the RFID readable/writeable tag is coupled to the drink container.

5. The regulated drink dispensing system of claim 1, wherein the RFID readable/writeable tag is integrated into the drink container.

6. The regulated drink dispensing system of claim 1, wherein the RFID readable/writeable tag is passively powered.

7. The regulated drink dispensing system of claim 1, wherein the one or more drink dispensing restrictions comprises a type of drink to dispense.

8. The regulated drink dispensing system of claim 1, wherein the one or more drink dispensing restrictions comprises a volume of drink to dispense.

9. The regulated drink dispensing system of claim 1, wherein the one or more drink dispensing restrictions comprises a number of refills permitted.

10. The regulated drink dispensing system of claim 1, wherein the one or more drink dispensing restrictions comprises an indication of whether alcoholic beverages are permitted.

11. The regulated drink dispensing system of claim 1, wherein the one or more drink dispensing restrictions comprises a number of alcoholic beverages dispensed.

12. The regulated drink dispensing system of claim 1, wherein the one or more drink dispensing restrictions comprises one or more customer preferences.

13. The regulated drink dispensing system of claim 1, wherein the one or more drink dispensing restrictions comprises customer information.

14. A method of regulating drink dispensing comprising:
identifying a drink container comprising a RFID readable/writeable tag in proximity to a first RFID read/write device;
writing one or more drink dispensing restrictions to the RFID readable/writeable tag with the first RFID read/write device;
identifying the drink container in proximity to a second RFID read/write device;
reading the one or more drink dispensing restrictions from the RFID readable/writeable tag with a second RFID read/write device; and
regulating dispensing by a drink dispenser according to the one or more drink dispensing restrictions.

15. The method of claim 14, further comprising:
updating the one or more drink dispensing restrictions to the RFID readable/writeable tag with the second RFID read/write device.

16. The method of claim 14, wherein the one or more drink dispensing restrictions comprises a type of drink to dispense.

17. The method of claim 14, wherein the one or more drink dispensing restrictions comprises a volume of drink to dispense.

18. The method of claim 14, wherein the one or more drink dispensing restrictions comprises a number of refills permitted.

19. The method of claim 14, wherein the one or more drink dispensing restrictions comprises one or more customer preferences.

20. The method of claim 14, wherein the one or more drink dispensing restrictions comprises an indication of whether alcoholic beverages are permitted.
